(19) United States
(12) Patent Application Publication
(10) Pub. No.: US 2026/0326145 A1
(43) Pub. Date: Oct. 22, 2026

(54) CARTRIDGE PISTON DEVICE FOR INSERTING INTO A CARTRIDGE, METHOD FOR VENTING AND CLOSING A CARTRIDGE, AND USE OF A CARTRIDGE PISTON DEVICE

(71) Applicant: KULZER GMBH, Hanau (DE)

(72) Inventors: Andreas GRUNDLER, Münzenberg (DE); Stephan DEKERT, Wehrheim (DE); Mike KONDZIELA, Weilburg (DE)

(73) Assignee: KULZER GMBH, Hanau (DE)

(21) Appl. No.: 19/115,032

(22) PCT Filed: Sep. 27, 2023
(86) PCT No.: PCT/EP2023/076812

§ 371 Date: Mar. 25, 2025

(30) Foreign Application Priority Data
Sep. 29, 2022 (DE) 10 2022 125 144.6

(51) Int. Cl. B05C 17/005

(52) U.S. Cl. CPC B05C 17/00579

(57) ABSTRACT

Cartridge piston devices and methods for inserting into cartridges and for venting and rear-side closing of the cartridges are provided. The devices and methods have a closure element for inserting into the piston, wherein the closure element or at least part of the closure element are inserted into the recess arranged so as to be guided adjustably in the insertion direction from an open position fluidically opening up the channel structure into a closed position fluidically closing the channel structure.

### FILED

The present invention relates to a cartridge piston device having a piston for insertion into a cartridge and for venting and closing the cartridge at the rear.

### BACKGROUND

When closing a cartridge filled with an in particular pasty product or cartridge content-in particular an impression material for the dental area-filled cartridge by inserting a cartridge piston device or a piston into the cartridge which is open at the back, there is usually air inclusions between the piston and the cartridge contents. For this purpose, it is known to provide the piston with a channel structure for venting. During insertion and further insertion of the piston into the cartridge, air can escape from the cartridge through the channel structure. In order that the cartridge content itself does not escape from the cartridge through the channel structure, it is known from DE 20 010 417 U1 to substantially close the channel structure and to release it only when the piston is pushed in. It is also known from DE 20 010 417 U1 to dimension the channel structure sufficiently small so that the pasty cartridge contents cannot pass through the channel structure. Furthermore, the channel structure can alternatively be closed by a rotary or rotary closing movement of a separate part, such as a closure element, after the insertion of the piston by an additional working step.

A disadvantage of the known cartridge piston device is that the venting of the cartridge is not user-friendly because additional tool is required. It may also happen that air inclusions remain in the cartridge when the channel structure is closed again too early or the venting is basically forgotten by the release of the channel structure, or is executed inadequately.

### DETAILED DESCRIPTION

It is therefore an object of the present invention to develop form the known cartridge piston device a more user-friendly design and to bring about a lower susceptibility to faults and an improvement of the venting. In particular, the process of closing the cartridge, comprising the insertion of the cartridge piston device, should be able to be carried out more quickly and more reliably.

The object is achieved by the features of claim 1, in a method with a cartridge piston device by the features of claim 12, a kit according to claim 12 and by the use according to claim 13. Preferred embodiments are in each case subject matter of the dependent claims and are disclosed in detail in the description.

According to the invention, a cartridge piston device for insertion into a cartridge and for venting and closing the cartridge at the rear is provided with a piston, in particular at least substantially cylindrical, and with a closure element for insertion into the piston. The piston has: a front side, a rear side facing away from the front side, in particular opposite to the front side, an outside with a circumferential sealing groove and/or seal for circumferential sealing on an inner surface of the cartridge, a recess in the region of the front side for inserting the closure element in an insertion direction, a channel structure fluidically connecting the recess and the rear side for venting the cartridge, which channel structure, at least substantially, points away from the front side to the rear side and points to a pull-out direction opposite to the insertion direction. The closure element inserted or insertable into the recess or at least a part of the closure element inserted into the recess is arranged or can be arranged adjustably in the insertion direction from an open position fluidically releasing the channel structure into a closed position fluidically closing the channel structure, wherein the piston has, in the direction of the front side, a support surface for the rear side of the closure element, wherein the support surface is formed substantially perpendicular to the central axis of the piston and which lies opposite the end face of the closure element.

In this case, it is preferred if the piston has a depression on the front side with a support surface for the rear side of the closure element, wherein the support surface is formed substantially perpendicular to the central axis of the piston. The depression is preferably made of cylindrical or conical or frustoconical configuration. The depression preferably has a depth of 0.01 to 10 mm, in particular of 1 to 10 mm, wherein the surface of the depression is preferably substantially planar and in particular has the pre-channel structure. The rear side of the closure element is preferably designed as a positive and the depression is designed as a negative with a larger circumference. Furthermore, the depression is preferably larger in the circumference than the circumference of the rear side of the closure element, in particular the circumference of a cover on the rear side of the end face. According to an alternative, a circumferential groove is formed in the depression with the closure element inserted and in particular fluidically closes the groove in the closed position of the cartridge piston device by means of a sealing auxiliary element, in particular a protruding seal, on the head side, in particular the end face and/or rear side, of the closure element, a circumferential sealing lip on the head side of the closure element and/or a circumferential sealing lip or seal on the cover.

The head side of the closure element advantageously has a rear side which lies opposite the end face.

It is particularly advantageous that the closure element is held fixed in the recess, in particular non-positively, in order to provide the open position, and/or in that the closure element, in order to provide the open position, strikes in the recess at least in the pull-out direction in the open position.

A support surface is defined as perpendicular, when formed at an angle to the central axis of the piston of 80° to 100°, in particular of 85° to 95°, particularly preferably plus/minus 2°, preferably the support surface is planar or planar, preferably the support surface has a pre-channel structure. The pre-channel structure can advantageously extend radially from the recess at least partially in the direction of the outer circumference of the piston, optionally the piston can have additional openings which extend from the front side to the rear side of the piston and can be closed by the closure element. The rear side of the closure element is preferably likewise planar or planar. The support surface can have a diameter of at least 11 mm, in particular of 11 to 23 mm, preferably of 17 mm optionally +/−2 mm, in particular +/- 1 mm. The rear side of the head side, in particular also the head side, of the closure element preferably has a diameter smaller than or equal to 2 mm, in particular less than or equal to 1 mm to 0.0001 mm, preferably less than or equal to 0.5 mm to 0 mm, than the support surface in order to allow the formation of a circumferential groove or at least one recess for fluidic exchange.

According to a preferred embodiment of the piston, a pre-channel structure extends as far as the recess in the support surface. Furthermore, it is preferred if, optionally, alternatively or additional openings are provided in the support surface, which openings are fluidically connected to the rear side of the piston or in the direction of the rear side of the piston.

The openings are advantageously arranged in the support surface and are arranged below the rear side opposite the end face of the closure element, in particular the support surface and the rear side are of substantially planar design and are advantageously formed substantially perpendicular to the central axis of the closure element and/or to the central axis of the piston. The recess and the channel structure can be components of an in particular central ventilation bore of the piston. A pre-channel structure preferably runs radially in the direction of the outer circumference of the piston starting from the recess. Particularly preferably, the channel structure in the recess and the pre-channel structure extends radially outward from the recess in the direction of the outer circumference of the piston, wherein the pre-channel structure is arranged in the support surface of the piston. In the closed position, the support surface of the piston comes into contact with the rear side of the closure element, preferably the rear side of the closure element rests on the support surface, preferably in a fluidically sealing manner. Both the support surface and/or the pre-channel structure are substantially planar. Furthermore, the support surface advantageously runs substantially perpendicular to the central axis of the piston. The central axis of the piston when the piston is inserted into the cartridge is substantially parallel to the central axis of the cartridge. The closure element, which is preferably designed as a plug and has a substantially rotationally symmetrical and/or a central axis, can be inserted into this venting bore. The closure element is preferably axially movable in the ventilation bore, or more precisely in the recess, specifically at least from an open position, which does not fluidically close the channel structure, up to a closed position closing the channel structure. In the installed state, that is to say at least when the cartridge is not yet vented and when the closure element is in the open position, the closure element or plug projects out of the piston and keeps the venting bore in the piston free; this allows a fluid connection from the front side to the rear side of the piston through the piston via the channel structure. When the piston is advanced or displaced in the cartridge, the air can escape from the cartridge through the channel structure or the venting bore through the piston out of the cartridge. As soon as the impression material filled into the cartridge comes into contact with the piston, in particular with the front side and/or with the closure element, and in particular as soon as a sufficiently large axial force acts on the closure element from the rather viscous or pasty impression material, the closure element is pressed further into the piston. In this way, the channel structure or the venting bore is closed or a fluidic passage through the piston is prevented, specifically only when the cartridge is at least approximately completely vented. This can cause a manual closing movement of the closure element on the piston to be dispensed with.

A piston for a cartridge is typically inserted at the rear into the cartridge, in particular into a piston opening, and closes it, at least approximately, preferably air-tight or fluid-tight. In this case, the piston usually has a front side facing in the direction of the cartridge content, in particular approximately planar, front side, a rear side facing away therefrom, an outside with a circumferential sealing groove and/or seal for circumferential sealing on an inner surface of the cartridge. It is also possible for the piston to face the cartridge content with the rear side. The cartridge piston device preferably has a planar surface at least in the region of the end face of the head side of the closure element, in order to enable automatic closing by the action of media on the media side. The front side is oriented on the media side, i.e. towards the cartridge content. The rear side is arranged on the apparatus side or on the conveying side.

The sealing groove and/or seal is designed in such a way that the piston is axially displaceable in the cartridge and at the same time fluidically seals the inner surface in the region of the contact. In particular, when the cartridge is filled or—apart from the piston opening—has no further (open) opening, the remaining volume between the piston and the space in the cartridge is reduced when the piston is pushed in, whereupon the pressure in the cartridge can increase. In other words, air would then be trapped and/or compressed in the cartridge, which would typically require venting. In any case, the cartridge content should usually not be permanently in contact with the air. For this purpose, a channel structure can be provided in the piston, which basically fluidically connects the front side and the rear side. Fluids are understood to be gases and liquids, so that gases and liquids can pass through a fluidic connection or a fluidic gap opening in the recess. Due to the channel structure, venting of the cartridge closed by the piston can take place insofar as the channel structure is at least temporarily, not closed.

The recess is to be understood as a (through-)bore, a material return, a hole, a guide, a receptacle and/or a (fluidic) passage, in particular a (fluidic) passage from the front side or rear side to the channel structure. The recess serves for receiving or inserting the closure element. The recess is preferably arranged centrally on the front side of the piston. In particular in the case of an approximately cylindrical or cylindrical piston, the recess can be arranged on the central axis of the piston, i.e. at least approximately centrally between the side surface of the piston. Here, the central axis of the piston is understood to mean an axis which extends at least through the front side and the rear side and is arranged at least approximately circumferentially equally spaced apart from the side surface.

The channel structure is understood to mean a bore, a material return, a hole, a groove, a slot, and/or a (fluidic) passage, in particular a (fluidic) passage from the rear side to the front side and/or from the rear side or front side to the recess. The channel structure serves, at least substantially, for air transport or fluidic connection. The recess and the channel structure can have identical or similar features and/or merge smoothly into one another.

It should also be mentioned that several, for example two, three, four or more recesses can also be provided on the front side. Alternatively, or additionally, a recess can also be provided on the rear side or two, three, four or more recesses can be provided on the rear side. It is also possible for a plurality of channel structures to be provided independently or also in dependence thereon. A plurality of channel structures can, at least substantially, run parallel and/or be connected to one another between the front side and the rear side. A recess, which—deviating from the rule—is provided on the rear side, can be connected to the same channel structure with which an in particular opposite recess is also connected on the front side. Overall, an improvement in the ventilation, the operability and the reliability of the cartridge piston device can be caused by one or more of the aforementioned features.

The closure element can be inserted into one or the recess for closing the channel structure, said closure element being designed to be adjustable from the open position into the closed position, optionally also to be adjustable back. In the open position, the channel structure is fluidically released, that is to say a fluidic passage through the channel structure is at least approximately unimpeded. In the closed position, the channel structure is fluidically closed, that is to say a fluidic passage through the channel structure is only hindered or not possible at all. Particularly highly viscous fluids or pasty cartridge contents can no longer pass through the channel structure with a suitable cross-sectional reduction in the region of the channel structure, so that a certain cross-sectional reduction can also fall under the term closed position, because a highly viscous content of the cartridge, which is stationary in or on the channel structure, can ultimately effectively prevent a passage from the remaining cartridge content and/or air through the channel structure.

The front side is usually facing the cartridge or cartridge content. The closure element inserted into the recess is then also facing the cartridge content and can come into contact with it. Deviation from this, it is also possible that the rear side faces the cartridge or cartridge content; then the recess on the front side of the piston is accessible from the outside or on the rear side of the cartridge when the piston is pushed into the cartridge, so that the closure element can be brought from the outside and/or manually into the closed position.

In the open position, the closure element is, for example, fixed or clamped against a displacement in and/or counter to the insertion direction, so that the closure element is secured against falling out of the recess and/or against further insertion or adjustment. However, with a sufficiently high application of force to the closure element in the axial direction or in the insertion direction, the closure element can be pushed further axially (and/or pulled out again). In this case, it is advantageous and preferred that the closure element is fixed and/or abuts, in particular in the pull-out direction, in the open position, but that a fluidic passage past the closure element is not impeded.

In the closed position, the closure element is fixed or clamped, for example, in a form-fitting and/or force-fitting manner against a displacement/adjustment in the insertion direction and/or in the pull-out direction.

Preferably, in particular at least in the closed position, a clamping force acts between the piston and the closure element. The clamping force can hold the closure element in its position, in particular because the clamping force can be oriented transversely to the central axis and/or to the insertion direction or pull-in direction.

Alternatively, or additionally, a latching connection and/or a snap connection is preferably provided between the closure element and the piston or the recess. However, the closed position-but also the open position—can be blocked or secured in a form-fitting manner in such a way that pulling out in the pull-out direction is only possible with high expenditure of force or not at all, for example caused by the latching connection and/or the snap connection, in particular by means of a snap ring.

According to a preferred embodiment of the invention, it is provided that the closure element has a head side having an end face. Here, the head side is to be understood to mean a portion of the closure element which is preferably located on the outside along the central axis of the closure element, while under the end face one or the outwardly facing surface of the head side is to be understood. In particular, the head side is an at least substantially piston-shaped, cylindrical and/or cylindrical section on the closure element. The head side can preferably be designed as a cover, in particular as a planar cover.

An engagement surface for applying force to the closure element overall is provided on the end face, so that it can be adjusted from the open position into the closed position. The introduction of force can be effected both by the cartridge content and manually. The end face is preferably arranged at least substantially parallel to the front side and/or to the rear side and/or transversely to the insertion direction or pull-out direction in order to achieve user-friendly operability.

When the piston is pushed into the cartridge, the enclosed air can first escape through the piston (because the open position is preferably then present). Subsequently, it is important whether the front side (case 1) or the rear side (case 2) faces the cartridge content. In the first case, when the front side meets the cartridge content, a force in the insertion direction will act on the end face; in particular, the closed position, for example during the venting and/or for the completion of the venting, in that the closure element is pushed into the piston by means of force introduction at the end face, specifically while the piston is pushed into the cartridge in the opposite direction. In the second case, an adjustment of the closure element is not readily effected, but only a standstill of the piston in the case of pressure rise in the ultimately vented cartridge is achieved; finally, the closure element must finally be manually, i.e. manually and/or by means of a device which, for example, already starts the piston, into the closed position. In one embodiment, it can be provided that the closure element is inserted into the piston by means of force introduction at the end face, and optionally, if no complete closure takes place into the closed position, the closure element can be transferred manually, for example on the foot side, into the closed position. Alternatively, a combination of the first case and the third case can be provided. In this embodiment, the closure element is thus optionally closed by means of force introduction at the end face of the piston and the end face of the closure element, and a further closure element can additionally be provided on the piston, which in this position allows renewed aeration of the piston content.

It is also preferably provided that, at least in the open position, the end face protrudes from the front side. It can then be seen clearly whether the open position is present or whether the open position is not correctly set, in particular if the closed position does not result in a distinct or distinct projection of the end face.

Alternatively, or additionally, it is possible that, at least in the open position, between the end face, in particular the head side, and the piston, in particular a lowering of the piston, a gap which opens fluidically in the recess, in particular as part of a pre-channel structure, is formed. A reliable venting function is provided via the gap, which reliably prevents a fluidic passage during the closing of the gap in the closed position, and/or which, at least approximately, is closed.

It is further alternatively or additionally provided that, at least in the closed position, the end face, at least substantially, terminates planar with the front side or is sunk-in the front side. Preferably, the head side can also be sunk-in further than in the open position, at least in the closed position.

Each of these above possibilities has the purpose that the closed position for the operator can be clearly seen in order to avoid further incorrect operations, for example the erroneous insertion of the piston with the closure element in the closed position.

According to a further preferred embodiment of the invention, it is provided that the head side and/or the end face and/or rear side is formed at least substantially round and/or corresponding to an, in particular and/or at least substantially, cylindrical depression on the recess. In particular, if the closure element corresponds, at least in sections, to the piston, for example to the recess and/or to the depression/depression on the piston, the closure element can be inserted into the piston in a simple and slightly error-prone manner, for example in order to achieve the open position and the closed position.

In preferred embodiments, in particular with sealing surfaces in the recess, the recess has a fluidic connection from the front side of the piston to the rear side of the piston, in particular the recess extends from the front side of the piston to the rear side of the piston. In particular, sealing surfaces provided on the inside in the recess, which can be designed, for example, conically and/or cylindrically, and with corresponding sealing surfaces of the closure element interaction. The corresponding surfaces of the closure element can be designed as a sealing element, cone, tapering, truncated cone, truncated cone section, cylindrical or comprise polygonal surfaces. In an alternative embodiment, the recess can be designed as a blind hole if, for example, the closure element has a rear side formed opposite the end face and the rear side acts as a sealing element. In particular, the end face and the rear side of the head side are designed as a lid, preferably as a planar cover. The plane of the lid of the closure element is preferably formed substantially perpendicular to the central axis of the closure element. The lid is preferably substantially planar, in particular at the end face and/or on the rear side. In a particularly preferred embodiment, the rear side acts as a sealing element in the closed position for sealing openings which correspond fluidically to the rear side of the piston.

It is helpful if the closure element, in particular the head side and/or the end face, and/or the piston, in particular the recess and/or the countersink, are designed to be round and/or corresponding to one another and/or into one another. In this way, errors in use, e.g. incorrect insertion of the closure element, can be avoided.

The ratio of end face of the closure element to the surface of the front side of the piston, without the proportion of end face of the closure element, is preferably from 1:5 to 1:20, preferably from 1:5 to 1:10. It is further particularly preferred if the end face of the closure element is substantially planar or planar. Particularly preferably, the end face of the closure element does not deviate from a planar plane by more than plus/minus 0.1 to 5 mm. Furthermore, it is preferred if an imaginary plane, in particular a planar plane, in the end face, in particular a substantially planar end face, of the closure element is substantially perpendicular to the central axis of the piston. In the present case, angles of from 81° to 90°, in particular from 85°to 90°, are preferably understood as being substantially perpendicular.

The pressing force of the closure element with an end face, in particular with a planar end face, preferably with an end face of 0.3 to 5 cm or alternatively with a ratio of 1:5 to 1:20 of end face of the closure element to the front side of the piston, is preferably greater than 5 N, particularly preferably from 200 N to 500 N, preferably from 200 N to 300 N.

Correspondingly means that it is preferred that a geometric positive of the one part/section and a geometric negative of the other part/section relative to one another are present at least in sections. If sections or parts correspond to one another, i.e. in particular the closure element to the recess and/or the head side to the countersink, both, if necessary, narrow gaps can be realized and a support of the sealing or closing of the channel structure can be made possible. It is also possible that the countersink, for example edge-side projections, has projections. Alternatively or additionally, the projections of the countersink can correspond to, for example, edge-side recesses of the head side. Alternatively or additionally, it is possible that the countersink has recesses and/or that the head side has projections. The projections or recesses can be partially circular or semi-circular, preferably wherein the corresponding central axis of the pitch circle or semicircle is arranged parallel to the central axis of the piston and/or closure element. In the manner of a toothing, the projections and recesses can engage in one another. Thus, the fluidic closure can be further improved in the closed position. This can also result in the operability being simplified, in particular because less force is required for adjusting the closure element, and/or because incorrect insertion and/or incorrect adjustment of the closure element is made more difficult. One, two, three, four or more projections or recesses can be provided, in particular arranged in a circumferentially distributed manner.

In a further preferred embodiment, the closure element has a sealing element, in particular a cone, for sealing on a sealing surface of the recess. The sealing element is in particular a conical or frustoconical section of the closure element, preferably convex and/or circumferential. A secure and precise application of the parts to one another can hereby be ensured. In particular, a cone, a conical shape or a truncated cone shape are well suited for a flat and thus sealing contact of the parts with sufficient elasticity of at least one part or material involved.

Alternatively, or additionally, the sealing element has a sealing ring (e.g. O-ring or sealing ring) or is formed by a sealing ring. In particular, in the open position, the sealing ring can only bear against the closure element and, in the closed position-for fluidic closure, bear against both the closure element and the piston, in particular the recess, particularly preferably in each case circumferentially on the closure element and piston.

In particular, the recess has one or the sealing surface. The sealing surface of the recess can be a conical or frustoconical section of the piston, preferably concave and/or circumferential. The sealing surface can also be cylindrical, at least approximately and/or partially.

The sealing surface and the sealing element can be pressed and/or clamped and/or clamped to one another in the closed position, in particular about the central axis of the closure element, in particular in such a way that there is a fluidic closure or sealing, that the channel structure is fluidically closed and/or that an adjustment of the closure element out of the closed position in the pull-out direction is made more difficult or, at least approximately, impossible.

The sealing surface and the sealing element can be present at a distance from one another in the open position, in particular in such a way that a fluidic closure or sealing is not present and/or that the channel structure is not fluidically closed and/or that the channel structure is fluidically released.

In a further preferred embodiment, the closure element has a sealing auxiliary element, in particular a sealing lip, for contact with a further sealing surface of the countersink, preferably wherein the sealing auxiliary element is arranged on the head side, in particular the end face and/or rear side, and/or circumferentially around the head side, in particular the end face and/or the rear side, in particular around the central axis of the closure element.

The sealing auxiliary element can release a gap between the piston and the closure element in the open position and/or close or seal it in the closed position. In the closed position, the sealing auxiliary element can lower the pressure acting on the sealing element when the piston is used in a cartridge, so that overall a higher pressure can be absorbed by the piston with the closure element when the closure element is in the closed position. The reliability can thus be further improved.

In a further preferred embodiment, it is provided that the closure element has a securing section for securing the closure element relative to the piston, in particular by means of a securing means of the piston, particularly preferably a snap ring of the piston. The securing portion and the securing means are preferably formed so as to correspond to one another, for example in the form of a connection between the piston and the closure element, which is clamped and/or latched in the insertion direction or pull-out direction. It is advantageous here that the axial play between the securing section and the securing means can provide the adjustability between the open position and the closed position and/or can ensure that the closure element cannot be pulled further out of the piston in the pull-out direction in the open position. Thus, loss of the closure element, in particular when the piston is inserted into the cartridge, is avoided.

In particular, the securing portion can be formed circumferentially around the central axis of the closure element and/or as a recess, projection and/or latching lug and/or can have this.

The securing means is in particular a part and/or section of the piston, for example in the region of the recess and/or the channel structure. The securing means can be designed as a snap ring or locking ring, as a latching lug and/or as a projection and/or have the same.

A snap ring is present, for example, as an annularly circumferential projection in a recess of a component or on a circumferential outer surface of a component, wherein this component can be the piston and/or the closure element, and has a mobility radially with respect to the central axis of the component. The mobility is preferably achieved by an elastic deformation of the snap ring itself. The snap ring is preferably formed by an annular, i.e. at least substantially circumferential, body which can be expanded and/or compressed.

The circumferential projection can, for example, be expanded briefly and finally snap into the securing section in sections when the closure element is inserted into the recess and reaches the open position, and preferably remains in the securing section in the positions between the open position and the closed position. This results, for example, in a form fit between the piston and the closure element that acts in the insertion direction or pull-out direction.

The closure element is particularly preferably formed symmetrically about its central axis in an alternative. Furthermore, the closure element comprises a head side, in particular a cylindrical head side, with a preferably flat end face, a sealing element, a guide section and optionally a taper. The end face can be arranged transversely, in particular perpendicularly, to the central axis of the closure element. A sealing auxiliary element, which is advantageously designed here as a seal, sealing lip, sealing lip with openings for a fluidic passage immediately before the closed position, can be arranged circumferentially around the head side, adjacent to the end face. The sealing auxiliary element preferably seals a circumferential groove around the head side of the closure element in the piston. For this purpose, the sealing auxiliary element is designed to seal all the way around in the closed position, in particular the countersink. A sealing element can adjoin the rear side, opposite the end face of the head side. A sealing element designed as a cone or cylinder optionally with at least one circumferential groove and/or circumferential sealing ring can optionally adjoin the rear side, opposite the end face.

The end face advantageously has a rear face which lies opposite the end face of the closure element. Alternatively, the end face of the closure element has a rear side of the closure element which lies opposite the end face of the closure element.

The closure element preferably has a securing portion which is configured as a recess extending around the central axis or as a projection extending around the central axis. A securing means or a snap ring or also a snap ring can engage and axially abut in the recess. Conversely, the projection extending around the central axis can engage in a depression in the recess as a securing means. The guide section can adjoin the securing section. Advantageously, the guide portion is formed circumferentially and preferably at least in portions cylindrically about the central axis. A tapering can follow the guide section. The closure element is advantageously formed substantially complementary to the recess and cut-out in the cartridge piston device. The recess is designed as a channel from the front side to the rear side, wherein the front side faces media side or cartridge inner side and optionally filled cartridge content and the rear side is arranged on the apparatus side or on the conveying side.

A further preferred embodiment of the invention provides that the closure element and/or the piston, in particular in the region of the cut-out and/or along the insertion direction or pull-out direction, has a venting option, in particular having groove(s) or slot(s). A fluidic exchange between the front side and the rear side of the piston can be made possible via the venting option, preferably when the closure element is in the open position. The ventilation possibility fluidically connects, for example, the recess to the channel structure when the closure element is in the open position; furthermore, no fluidic exchange can preferably take place via the venting option if the closure element is in the closed position, in particular because the ventilation possibility can be partially covered, for example.

The venting option, in particular the groove or the slot or also the grooves or slots, can extend from the sealing element to a further axial location of the closure element facing away from the sealing element on the closure element. If a plurality of grooves or slots are provided in the ventilation possibility, the same applies to the individual grooves or slots. Alternatively or additionally, the venting option can extend from the sealing surface as far as a point further away from the sealing surface and/or in the direction of the rear side of the piston. The venting option does not have to directly adjoin the sealing surface or the sealing element at one of its two ends, but rather can overlap or be formed at a distance from the sealing surface or sealing element.

In particular, the closure element, at least in the open position, substantially blocks the cross-section of the recess, but the venting option ensures a certain fluidic connection—for example for venting—along the closure element. In particular, the venting option provides a fluidic connection between the recess and the channel structure, specifically in particular in the region in which the cross section of the recess is substantially blocked by the closure element.

A preferred embodiment of the invention is characterized in that the piston has a pre-channel structure on the front side and/or on the rear side. A pre-channel structure is preferably to be understood as a further channel structure which—in particular indirectly or directly—is connected upstream and/or downstream of the channel structure. Via the pre-channel structure, in particular the venting function is improved in that the air to be discharged is received over a large cross section and/or at a plurality of regions as only in the immediate region of the recess and can be removed or tapped off via the piston. Without a pre-channel structure, the region at which air can be discharged at all would only lie directly in the region of the closure element and thus be comparatively small.

In particular, the pre-channel structure extends transversely, i.e. at least substantially perpendicular, to the insertion direction or pull-out direction and/or to the central axis of the piston. Alternatively, or additionally, the pre-channel structure covers the front side and/or the rear side at least substantially and/or extends over the front side and/or the rear side at least substantially flat and/or star-shaped and/or distributed around the central axis, in particular uniformly.

The pre-channel structure can fluidically connect the front side and/or sections of the front side to the recess, the channel structure and/or the rear side. Alternatively or additionally, the pre-channel structure can fluidically connect the rear side and/or sections of the rear side to the channel structure and/or the recess.

A further preferred embodiment is characterized in that the pre-channel structure, in particular on the piston, has recesses which are open towards the outside and/or towards the cartridge, preferably wherein the depressions are arranged at or within the front side and/or the rear side, at least approximately, in a surface-covering and/or distributed manner.

The in particular constant width of the pre-channel structure can be in the range from 0.01 mm to 1 mm, preferably in the range from 0.1 to 0.5 mm, particularly preferably the width is 0.2 mm +/−10%. This is a sufficiently narrow value, so that in particular pasty cartridge contents can only penetrate into the pre-channel structure with difficulty or not at all.

The depth of the pre-channel structure or a depression of the pre-channel structure, in particular measured from a plane on the front side in the insertion direction and/or along the central axis of the piston, is in particular in the range 0 to 10 mm, preferably 0.1 to 5 mm, in particular 2 to 4 mm. In particular, the pre-channel structure is less deep away from the central axis than close to the central axis. In this case, the pre-channel structure can open into an edge depression in the vicinity of the outside, in particular continuously, with an identical, similar or completely different depth.

In particular, the pre-channel structure faces or is open to the cartridge content. If the pre-channel structure connects more than only the region of the recess on the front side that is preferably central, preferably at the front side of the piston, directly or indirectly to the rear side, edge-side regions of the front side can also be vented well.

On the front side and/or the rear side, an edge depression, in particular circumferential on the respective side, can be provided, in particular in which the pre-channel structure runs smoothly or opens continuously. An improvement of the venting is effected via the edge depression, because otherwise air can be enclosed in the edge region without an edge depression during the venting of the cartridge. The edge region preferably has an inner diameter and an outer diameter. The outer diameter corresponds in particular to the diameter of the piston. An edge region comprises, in particular without strippers and/or without a depression, the inner diameter and the outer diameter. The pre-channel structure preferably opens out at the inner diameter of the edge region, in particular as explained above in the edge depression. The edge recess can correspond to a venting groove. In this case, it may be further preferred if the edge depression extends at least partially to completely radially from the inner diameter to the outer diameter of the edge region and extends partially to completely, in particular circular or with interruptions, in particular between the depressions of the pre-channel structure.

The diameter of the head side of the closure element preferably has at least 8 mm, preferably at least 10 mm. Furthermore, it is preferred if the diameter of the piston is greater than or equal to 20 mm and optionally less than or equal to 150 mm, in particular greater than or equal to 22 mm and optionally less than or equal to 100 mm. More preferably, the front side of the piston has a diameter of greater than or equal to 20 mm, in particular of greater than or equal to 22 mm and optionally less than or equal to 150 mm. Particularly preferably, the inner diameter of the edge region of the front side of the piston has a diameter of greater than or equal to 20 mm, in particular of greater than or equal to 22 mm and optionally less than or equal to 150 mm, in particular less than or equal to 100 mm.

The ratio of the diameter of the head side of the closure element to the diameter of the piston, in particular of the diameter of the front side of the piston, further preferably of the inner diameter of the edge region of the piston is from 1:2 to 1:10, preferably from 1:3 to 1:7, particularly preferably from 1:5, in particular with plus/minus 25%, in particular plus/minus 10%, preferably plus/minus 5%. Particularly preferred is a ratio of the diameter of the closure element, in particular of the diameter of the cover of the head side, to the diameter of the edge depression, in particular to the inner diameter, of 1:5, in particular with a standard deviation of plus/minus 5%.

The head side of the closure element, in particular the cover of the closure element, can have a surface, in particular an end face, of 39 to 80 mm², preferably of 45 to 55 mm², particularly preferably of 50 mm², in particular of a circular end face, preferably with a deviation of plus/minus 15%, preferably of 5%.

The front side of the piston can preferably have a surface of greater than or equal to 200 to 300 mm², preferably of 220 to 270 mm² , particularly preferably of 250 mm², in particular as a circular surface, preferably with a deviation of plus/minus 15%, preferably of 5%.

The front side of the piston is preferably greater by a factor of five, in particular at least by a factor of 1, 5 to 5, preferably by a factor of 3 to 5, preferably 4 to 5, as the surface of the head side of the closure element, in particular as the surface of the cover of the closure element. Preferably, the front side of the piston, particularly preferably the surface of the front side within the inner diameter of the edge region, is preferably greater by a factor of five, in particular by a factor of 1.5 to 5, preferably by a factor of 3 to 5, preferably 4 to 5, as the surface of the head side of the closure element, in particular as a surface of the lid of the closure element.

Furthermore, it may be preferred if the edge recess, in particular as a venting groove, has a width of 0.2 mm to 1 mm, preferably of 0.2 mm to less than or equal to 0.6 mm, and/or has a depth of less than or equal to 2 mm, in particular of 0.001 mm to less than or equal to 2 mm.

The pre-channel structure advantageously has a width of less than or equal to 0.6 mm, in particular from 0.001 to 0.6 mm, preferably from 0.2 to 0.6 mm and/or a depth of less than or equal to 2 mm, in particular from 0.001 mm to 2 mm, preferably from 0.01 to 2 mm. The pre-channel structure is preferably designed as a groove-shaped depression, in particular as an open groove-shaped depression. The pre-channel structure comprising the depressions, in particular groove-shaped depressions, can run from the center of the front side, in particular the recess and/or the countersink, into the edge region and open in particular in the edge depression of the edge region. The edge recess can be designed as a venting groove into which the depressions of the pre-channel structure open. It is further preferred if the entire surface of the openings of the pre-channel structure, in particular of the depressions of the pre-channel structure, and optionally opening of the edge recess, the total surface of the piston, in particular the front side of the piston, preferably the total surface of the piston with the edge region and optionally with an edge depression, particularly preferably up to the outer diameter of the edge region, is less than or equal to 6%, preferably from 0.0001 to 6%, preferably from 0.01 to 6%, more preferably from 0.01 to 5%. In particular, the pre-channel structure is designed in such a way that a typical cartridge content can only penetrate into the pre-channel structure with difficulty or not, and in such a way that air can penetrate into the pre-channel structure. This is preferably achieved by sufficiently narrow channel-shaped, slot-shaped and/or groove-shaped geometric elements in the pre-channel structure, into which a fluid or a pasty cartridge content that is to be viscous can penetrate only with difficulty or not. Therefore, slot-shaped or groove-shaped depressions are particularly advantageous for venting the cartridge, in particular for use as a pre-channel structure, but, if necessary, also or alternatively as a channel structure.

The pre-channel structure(s), in particular having depressions, can be arranged in a star-shaped manner on the front side and/or on the rear side of the piston. This is to be understood as meaning that the individual components of the pre-channel structure point outwards approximately starting from the central axis of the piston or the center of the front side/rear side and are arranged uniformly distributed around the central axis or the center.

In this case, it is preferred if radially, in particular spoke-shaped or star-shaped, groove-shaped recess and/or depressions are formed from the center of the front side, in particular from the recess and/or from the countersink, from at least two, preferably at least four, particularly preferably two to fifty, outwardly open, in particular open toward the cartridge, which form the pre-channel structure and in particular extend as far as the edge region, and open in the edge region, in particular in the present case in an edge depression running around the front side of the piston.

The same applies to the venting option(s), in particular having grooves or slots, which can be arranged in particular in the channel structure in a star-shaped manner around the central axis. It can be assumed that the grooves or slots particularly preferably have the same structural design as depressions.

In a further preferred embodiment of the invention, it is provided that the closure element and/or the piston is formed from one/more of the following materials: thermoplast, elastomer, thermoplastic elastomer, duromer or thermoset. The piston is preferably produced from a thermoplastic, such as polypropylene (PP), polyethylene (PE), mixtures of PP and PE or corresponding thermoplast filled with inorganic fillers. The closure element can be made of a thermoplast, preferably made of a thermoplastic elastomer (TPE) and/or contains them. Typical thermoplastic elastomers include PP, PE or mixtures thereof with latex or silicone. Examples are TPA (TPE-A), such as thermoplastic polyamide elastomers, TPC (TPE-E), such as thermoplastic copolyester elastomers, TPO (TPE-O), such as thermoplastic elastomers based on olefin, such as PP (EPDM), TPS (TPE-S), such as thermoplastic styrene block copolymers, TPU (TPE-U) thermoplastic elastomers based on urethane. The abovementioned polymers can be present as a homopolymer, co-polymer or else as a block-co-polymer and as mixtures thereof.

In particular, when the closure element is produced from a material which is softer or more elastic than the piston, the sealing function can be achieved well in the closed position, and the locking or clamping of the closure element, in particular in the closed position, can also be further improved. Any embodiments of the three features: “pre-channel structure”, “channel structure” and “venting option” among the three mentioned features can be applied as desired to any other desired feature of the three features.

Alternatively, or additionally, the venting option and/or the pre-channel structure may be a component of the channel structure or of the recess or be a component of both. Therefore, with reference to the channel structure and/or from the recess, reference may also be made at the same time to the venting option or the pre-channel structure. In other words, a smooth transition or not clearly defined transition between the recess (including the countersink), the channel structure, the pre-channel structure and/or the venting option may optionally be present.

According to an alternative, the closure element can be designed to be at least substantially rigid or inflexible. In particular, rigid or inflexible means that there is no substantial and/or no elastic deformability of the closure element provided due to the design. Rigid or inflexible also implicitly and in particular also means that the closure element always has an approximately identical functionality, at least substantially, independently of the material, to the extent that the material used is designed to be closed-pored. The closure element can therefore be made of metal, plastic or ceramic. This material-related idea results from the fact that the listed materials or materials listed in their properties (density, hardness, modulus of elasticity, notch impact work, etc.) are highly different due to their geometry and not on account of their rigidity or rigidity resulting from the properties.

Flexibility can function as a closure element. According to also preferred embodiments, the closure member may comprise a core of a rigid material and a coating over the core of flexible material. In a further alternative, the closure element is formed integrally from an elastic, thermoplastic material, such as TPE. Preferably, all sealing surfaces of the closure element and/or of the piston are formed from an elastomeric, thermoplastic material or are coated therewith. Thus, a guide section, which at the same time acts as a seal, can also be made of an elastomeric, thermoplastic material.

The closure element and/or the piston can in each case be produced as an, in particular one-piece component, preferably an injection-molded component.

In particular, the closure element can have a guide section. The guide section can be a section which is separate from other sections or parts of the closure element and/or extends around the central axis. However, the guide section can also be formed by a plurality of non-circumferential sections or points on the closure element. In particular, the guide section of the head side and/or end face can be at least substantially opposite. The guide section can in particular adjoin a tapering of the reinforcing element, which facilitates insertion into the recess. The guide section of the closure element can be rigid or elastic. According to a preferred alternative, the closure element is formed integrally from a thermoplastic elastomer. In a further alternative, the closure element can be formed in multiple parts and, for example, comprise a rigid core and optionally a rigid core in the head side, which core is enveloped by elastic material, in particular an elastic thermoplast.

A clamping force or the clamping force, in particular in the closed position, between the piston and the closure element, can result from the fact that the closure element, in particular on the guide section, has an oversize with respect to the recess. From the oversize, for example, the closure element inserted into the recess results in static friction between the piston and the closure element, in particular in the region of the guide section, which must be overcome during the adjustment of the closure element.

A stripper for abutting and sealing on an inner surface of a cartridge can be provided circumferentially around one or the edge of the front side and/or the rear side and/or on the outside. The stripper can strip off from the inner surface of the cartridge.

A plurality of strippers can also be provided. A sealing lip can also be provided as a scraper. The sealing lip can point to the front side or to the rear side. In particular, the scraper can run at least substantially parallel to and/or next to the sealing groove or seal.

A further proposal is that an in particular unfilled cartridge, preferably having a piston opening for a cartridge piston device, is provided together with one or the cartridge piston device. Thus, a user can already benefit from the advantages of the invention mentioned in the application, for example in that the user only needs to fill the cartridge and/or need to use the provided piston with the closure element in the open position.

Because of the simple and reliable venting function of the proposed cartridge piston device or cartridge, it is also possible to store very sensitive cartridge contents or impression materials in a cartridge, because the venting can take place particularly easily and quickly.

Each feature mentioned in a singular can also be used in a plurality and can produce synergistic advantages; it is likewise not necessary to explicitly refer to a plurality of said features in a number of features; it is not necessary to explicitly refer to this in the individual case. In particular, in order to give a non-exhaustive enumeration-individual or several: ventilation possibilities, pre-channel structures, channel structures, recesses, sealing surfaces, countersinks, closure elements, end faces, head sides, rear side, securing sections, guide sections, sealing elements, tapers and so on can be provided. In particular, reference is made here to the list of reference signs.

The invention further relates to a method for venting and closing a cartridge with a cartridge piston device. The cartridge piston device can have a piston having a channel structure and a closure element for closing the channel structure by inserting the closure element into a recess in the region of the front side of the piston, which can be transferred into a closed position by adjusting the closure element or can be formed according to one of the remaining claims.

The method can comprise the following method steps:
a. providing a cartridge, in particular a cartridge filled with cartridge contents, with a piston opening,
b. providing the cartridge piston device, in particular with the closure element, inserted into the recess and/or in an open position,
c. inserting the cartridge piston device into the piston opening, wherein a/the open position is present,
d. venting the cartridge by inserting the cartridge piston device, wherein the closure element can be held in a fixed manner by the recess and/or can or can strike in the pull-out direction, and, preferably, in particular venting the cartridge by inserting the cartridge piston device until the front side comes into contact with a cartridge content, preferably further insertion of the cartridge piston until the closure element passes through the cartridge content, in particular by the build-up pressure of the cartridge content, to the closure element into the closed position,
e. closing the cartridge, by adjusting the closure element into the closed position by contact of the cartridge contents with the closure element and/or by applying force to the closure element, preferably during or after step d, in particular automatic or automatic closing, and optionally
f. preferably obtaining the closed position of the cartridge piston device.

In step e., the closing is preferably carried out automatically or independently in that the cartridge piston device is inserted through a drive shaft in the direction of the medium into the cartridge filled with cartridge contents, and the closure element is automatically inserted into the piston by the force introduction through the cartridge content (media side).

Individual features of the cartridge piston device or cartridge can be used in accordance with the aforementioned method and in the aforementioned use. The advantages apply accordingly.

The invention further relates to a kit comprising a cartridge and at least one cartridge piston device, in particular comprising the one or two cartridge piston device and a single chamber or double chamber cartridge.

The invention also relates to a closure element for use with a piston, wherein in particular a piston with an inserted closure element forms a cartridge piston device, wherein the closure element has a head side with an end face, a rear side which lies opposite the end face, and a sealing element. The head side is preferably designed as a lid or cover, in particular as a cover with a planar rear side which lies opposite the end face of the head side. The closure element comprises a head side, at least one sealing element, optionally a securing portion, optionally a guide portion, and optionally a taper and optionally a second guide portion.

According to an alternative embodiment, the closure element has on its head side an opening which extends from the end face to the rear side of the head side and is optionally guided through the closure element to the opposite end of the closure element, wherein in particular the opening on the rear side of the closure element opposite the end face has at least three elements, each of which has at least one sealing surface, preferably at least two sealing surfaces, which are formed from the outer circumference of the elements towards the opening and, as a result of external application of force to the outer surfaces of the elements, the sealing surfaces of the elements come to lie on one another and thereby close the opening on the side of the closure element facing away from the end face.

Wherein the at least three elements, in particular in the initial position or the open position in the piston, have an approximately cylindrical circumference, and in particular in the closed position after insertion into a conical recess of the piston, the sealing surfaces of the elements come to lie on one another and close the opening in a fluid-tight manner, in particular in the closed position.

In this embodiment, the piston has a cylindrical recess extending from the front side to the interior of the piston and from there at least partially conically to the rear side. The protruding closure element can be inserted into this recess and, inserted into this recess, closes the recess and the opening of the closure element for a fluid passage, in particular the closed position is present.

The subject matter of the invention is also a piston for insertion into a cartridge which has a front side, a rear side facing away from the front side, an outside with a circumferential sealing groove and/or seal for circumferential sealing on an inner surface of the cartridge, with a recess in the region of the front side for insertion a closure element in an insertion direction, and optionally a channel structure fluidically connecting the recess and the rear side for venting the cartridge, and the piston has, in the direction of the front side, a contact surface formed substantially perpendicular to the central axis of the piston, in particular in a depression on the front side of the piston, for the rear side of the closure element which lies opposite the end face of the closure element.

Furthermore, the object is achieved by using a cartridge piston device for insertion into a cartridge and closing this cartridge at the rear. In this case, the cartridge piston device has a piston having a channel structure and a closure element for closing the channel structure by inserting the closure element into a recess of the piston and by adjusting the closure element into a closed position, or is designed in particular according to the preamble of claim 1 or according to one of claims 1 to 10. In this case, the closing of the cartridge includes an adjustment of the closure element into the closed position, wherein the adjustment is effected by contact of one and/or the cartridge contents with the closure element and/or by applying force to the closure element.

In the following, the invention is explained by way of example with reference to the attached drawings on the basis of preferred exemplary embodiments, wherein the features illustrated below can represent an aspect of the invention both individually and in combination.

### BRIEF DESCRIPTION OF THE DRAWINGS

FIG. 1A-C: a cartridge piston device inserted into a cartridge filled with cartridge contents prior to venting in an open position (FIG. 1A), during venting (FIG. 1B) and after venting in a closed position (FIG. 1C) in a partially sectioned side view,

FIG. 2: a closure element in a side view,

FIG. 3A: is a top view of a piston,

FIG. 3B: shows a further piston in a partial top view,

FIG. 4A: the cartridge piston device consisting of the closure element and the piston of FIG. 2 and FIG. 3A, with the closure element inserted into a piston in an open position in a partially sectioned side view,

FIG. 4B: the cartridge piston device of FIG. 4A with the closure element in a closed position in a partially sectioned side view, and

FIGS. 5A-C: shows another cartridge piston device according to the invention in a view from the rear side (FIG. 5A), from the outside (FIG. 5B) and from the front side (FIG. 5C).

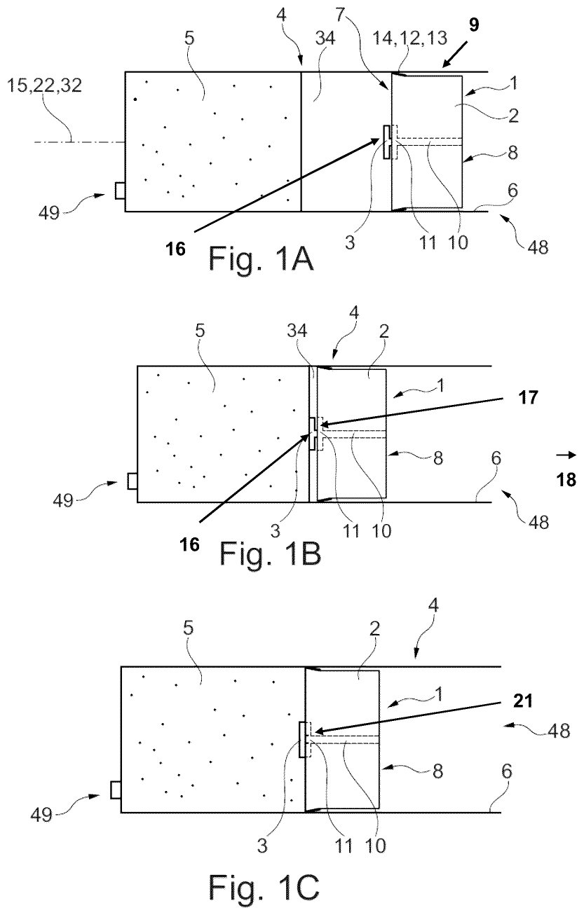

FIG. 1A-C shows a cartridge piston device 1 with a piston 2 and a closure element 3, which is inserted or slided in into a cartridge 4. The cartridge 4 is filled with cartridge contents 5, a highly viscous or pasty mass and is at least substantially cylindrical. One or the front side 7 of the piston 2 faces the cartridge contents 5, one or the opposite rear side 8 of the piston facing away from the cartridge contents 5. It is also not shown, but it is also possible that the rear side 8 of the piston 2 faces the cartridge content 5 or comes into contact with the cartridge contents 5.

The piston 2 seals at the contact points to an inner surface 6 of the cartridge 5 in the region of the outside 9 of the piston 2 by means of a seal 13 which is inserted into a sealing groove 12 and is designed as an O-ring. Furthermore, strippers 14, which are in contact with the inner surface 6, ensure that no or at least substantially no cartridge content 5 comes into contact with the seal 13. In FIG. 1A, the closure element 3 is axially guided and received in an open position relative to the piston 2 and in a recess 11 of the piston 2, as a result of which a fluidic connection via the recess 11 is possible over a channel structure 10 in the piston from the front side 7 facing the cartridge content 5 to the rear side 8 facing away from the cartridge content. Via the fluidic connection present in the open position, venting of an optionally remaining cavity 34 can take place during a displacement or adjustment of the piston 2 with the closure element 3 along a central axis 15 in the cartridge, in particular as long as the closure element 3 is not in contact with the cartridge contents 5.

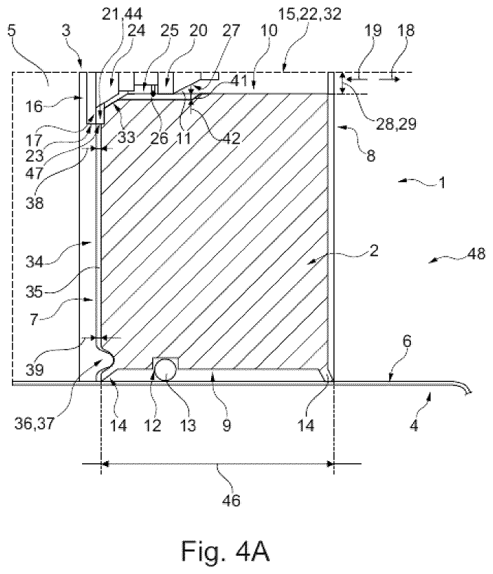

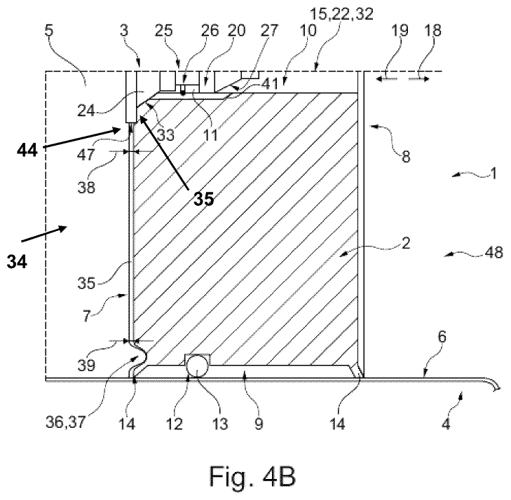

In FIG. 1B, the closure element 3 is in contact with the cartridge contents 5 via its head side 17 having an end face 16 and still has the open position. In this position, any further adjustment of the cartridge piston device 1 along the central axis 15 (see FIG. 4A) of the cartridge 4 in the direction of the cartridge contents 5 exerts a force on the closure element 3 in the axial direction or in an insertion direction 18 of the closure element 3 relative to the piston, since the cartridge content 5 makes resistance to the penetration of the closure element 3. Since the force is typically applied to the cartridge piston device 1 for inserting the cartridge piston device 1 into the cartridge 4 on the rear side 8 of the piston 2, the application of force to the closure element 3 on the part of the cartridge contents 5 can gradually lead to a pressure rise in the region of the cartridge contents 5 and to an adjustment of the closure element 3. The closure element 3 can then be adjusted from the open position shown in FIG. 1B into a closed position shown in FIG. 1C, in particular if the introduction of force is large enough.

Due to the fact that an adjustment of the closure element 3 in the piston 2 or in the recess 11 requires a certain introduction of force (because the closure element is guided and fixed or held in place via a guide section 20), a further venting of the cartridge 4 is first carried out before the closure element 3 can have reached at least approximately the closed position. Thus, in the transition from the state of FIG. 1 B to FIG. 1C, both a flow or deformation of the presently pasty cartridge content 5, in particular around the closure element 3 or the head side 17 (see FIG. 1 A) and/or on the front side 7, as well as an adjustment of the closure element 3, which is to be attached thereto, into the closed position. The closure element 3 in the closed position, as shown in FIG. 1C, causes no fluidic passage to take place on the rear side 8 of the piston from the sides of the cartridge contents 5 or the front side 7, because the channel structure 10 in the piston is fluidically sealed by sealing the closure element 3 in the piston or in the recess 11. In this case, the closure element 3 is immersed in a recess 21 in the piston 2 and protrudes slightly from the front side 7.

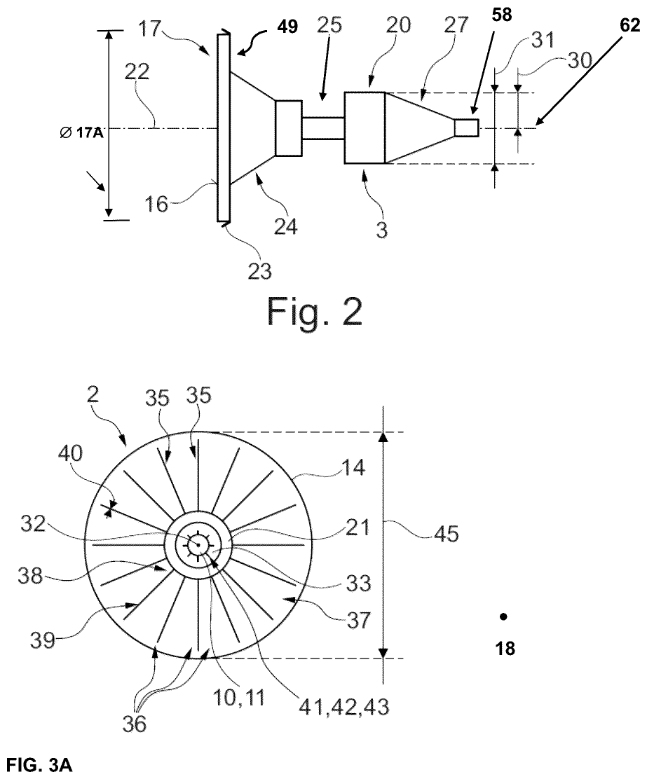

FIG. 2 shows a single closure element 3 of a further cartridge piston device 1 according to the invention. The closure element 3 is formed symmetrically about its central axis 22. A cylindrical cop plate 17 with a flat end face 16 is arranged on an outside of the closure element 3 along the central axis 22. The end face 16 is arranged transversely, in the present case more precisely perpendicular, to the central axis 22. Arranged circumferentially around the head side 17, adjacent to the end face 16, is a sealing auxiliary element 23, which in the present case is designed as a sealing lip 23. The sealing auxiliary element 23 can seal all around, for example in one or the countersink 21.

A sealing element 24 designed as a cone 24 adjoins the rear side 49, opposite the end face 16 of the head side 17. The sealing element 24 is formed circumferentially and optionally convex about the central axis 22. The sealing element 24 is reminded of the shape of a countersunk head. Not shown is a sealing element 24 which is at least substantially circumferential and cylindrical (here: instead of conical) and/or has at least one sealing ring or O-ring.

Furthermore, the closure element 3 has a securing section 25, which is designed as a recess 25 surrounding the central axis. A securing means 26 (see FIG. 4A) or a snap ring 26 (see FIG. 4A) or also a snap ring can engage and axially abut in the recess 25.

The closure element 3 has a guide section 20, which in the present case adjoins the securing section 25. The guide section 20 is designed in such a way that it can be inserted into a recess 11 and is suitable for guiding the entire closure element 33 (see FIG. 4A), for example along the central axis 22. For this purpose, the guide section 20 is formed circumferentially and preferably at least in sections cylindrically about the central axis 22.

It is not shown that one or the guide section 20 can alternatively or additionally be arranged at a different axial location on the central axis 22 (another than for example in FIG. 2) of the closure element 3. For example, the guide section 20 can also adjoin the sealing element 24 or to the head side 17. It is also not shown and possible that a plurality of guide sections 20 are provided.

The closure element 3 has a tapering 27, which in the present case is in the form of a truncated cone or a truncated cone section (i.e. as a truncated cone or truncated cone section). When the closure element 3 is inserted into a corresponding recess 11 for the closure element 3 (not shown in FIG. 2), the tapering 27 aids in a corresponding recess 11 for the closure element 3. Because the tapering 27 and optionally a second guide section 58 in the present case adjoin the guide section 20 and basically forms the end of the closure element 3 opposite the head side 17, the closure element 3 can be inserted with the tapering 27 first into the corresponding recess 11 and can be brought directly via the guide section 20 into a guided position. The corresponding (in FIG. 2 Specifically, in at least one section, the recess 11 has a radius 28 which corresponds at least substantially to the radius 30 of the guide section or is smaller (i.e. by up to 0.1%, 1% or 5%) than the latter. The rear side 49 of the head side 17 opposite to the end face 16 can also act as a sealing surface. A second guide section 58, which can serve for centering the closure element in the insertion direction, can adjoin the taper 27.

The illustrated and thus preferred closure element 3 is preferably designed as an injection-molded component, which has been produced, for example, by means of an at least two-part injection molding tool (not shown). The at least two-part injection molding tool can move up and down transversely to the central axis 22 of the closure element 3, in particular because the contour of the closure element 3 has no undercut along the central axis 22 and/or is rotationally symmetrical about the central axis 22.

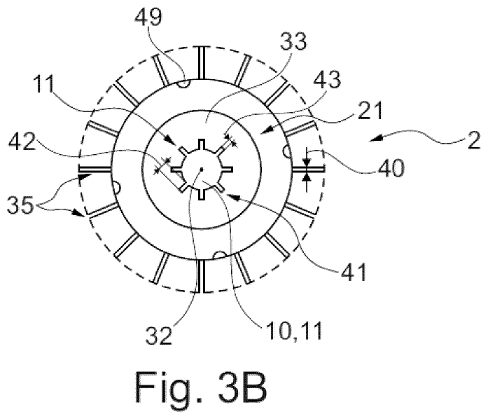

FIG. 3A shows a piston 2 according to the invention with a recess 11 in the region of a front side 7 for inserting the closure element 3 in the insertion direction 18 (into the plane .). The piston 2 is round and substantially cylindrical, wherein the recess 11 is arranged centrally on a central axis 32 of the piston 2. The insertion direction 18 lies on the central axis 32 and points into the illustrated plane or is perpendicular thereto. The recess 11 is basically formed by a bore with diameters of different diameters in the piston 2. The recess 11 has a conical sealing surface 33, which corresponds to the sealing element 24 of the closure element 3 of FIG. 2 designed as a cone 24. Furthermore, the recess 11 has a substantially cylindrical recess 21. The countersink 21 corresponds to the end face 16 of the closure element 3 of FIG. 2.

Depressions, in particular sixteen depressions 35, of a pre-channel structure 35 extend from the center of the front side 7 to the edge region 36 of the piston, where the depressions 35 open into a circumferential edge depression 37. The depression 35 are slot-shaped or groove-shaped, i.e. formed as slots and/or grooves. In the present case, the depressions 35 are each a multiple deeper (into the plane shown) than the depressions 35 are wide, in particular by two to twenty or even thirty times or any multiple between them.

In the present case, the depressions 35 in the vicinity of the central axis 32 are also deeper than further away from the central axis 32. Adjacent to the countersink 21, a single depression 35 is twice as deep (there is a depth 38) as at its end facing away from the central axis, at which the depression 35 has the greater depth 39. In the present case, there is a slope of the depth 38, 39 of the depression 35 from the edge region 36 rising up to the recess 11. The depths 38, 39 are at least approximately adjacent to one End of a single depression 35, for example at most 10% or 5% or 2% spaced apart from the end with respect to the total length of the individual depression 35.

In the edge region 36 of the piston 2, at the end of the depressions 35 facing away from the central axis 32 or in the vicinity of the outside 9, the edge depression 37 running around on the front side 7 is provided, into which in the present case the depression 35 also runs smoothly or opens continuously. The width 40 of the pre-channel structure 35 or depression 35 is in each case at least approximately constant.

In a star-shaped manner from the center of the front side 7, grooves or slots 41 of a venting option 41 extend from the recess 11 or likewise from a channel structure 10 of the piston 2 adjoining the recess 11 in a deeper plane. Eight panels 41 are provided. The components of the venting option 41 are formed as slots 41 and/or grooves 41 and run at least substantially parallel to the recess 11 and the channel structure 10, i.e. into the plane shown. In the present case, the venting option 41 has an at least substantially similar or identical depth 42 and width 43 as the pre-channel structure 35.

The following preferred embodiments of the venting option 41 are not shown for good fluidic continuity with respect to the venting and as poor a fluidic passage as possible of, in particular, paste-like cartridge contents 5. The depth 42 and/or width 43 is preferably selected to be constant, wherein an inlet or outlet with deviating depths 42 and widths 43 can be provided at the end of the venting option 41. For example, the depth 42 can be selected in the range from 0.1 mm to 5 mm or in the range from 0.5 mm to 3 mm, in particular in the range from 1 mm to 2 mm . The width 43 can be selected in the range from 0.01 to 2 mm or in the range from 0.05 to 1 mm, in particular in the range from 0.1 mm to 0.5 mm.

In FIG. 3A (but also FIGS. 1A-C and 4A-B), a scraper 14 designed as a sealing lip is provided on the piston circumferentially around the edge of the front side 7 and the rear side 8, which scraper 14 can strip cartridge contents 5 from an inner surface 6 of a cartridge 4 because it has an at least circumferential line-shaped end face and can rest tightly against an inner surface 6 or can even rest against it. The scraper 14 can be pressed in a circumferential manner around the central axis 32 in the direction of the central axis 32. In this case, the wiper 14 points away from the front side 7 or from the rear side 8 at the front side 7. The wiper 14 on the rear side 8 points away from the rear side 8 or from the front side 7.

The piston 2 shown in FIG. 3B is developed solely with respect to the piston 2 of FIG. 3A to the effect that four edge-side projections 49 are provided at the edge of the countersink 21. The projections 49 can correspond to corresponding recesses 23 (not shown) on the closure element 3 or on the head side 17 thereof. The recesses 23 can be provided, for example, at the point/in the region of the sealing auxiliary element 23 and/or as and/or in addition to the sealing auxiliary element 23 on the closure element 3. The recesses 23 can be provided circumferentially and/or distributed on the head side 17 and/or correspond to the projections 49.

Not shown in FIGS. 3A-B, but present, is a rear side 8 of the piston 2, which is arranged facing away from the illustrated front side 7 of the piston parallel to the front side 7. An outside 9 of the piston 2 is provided circumferentially around the front side 7 and the rear side 8. The outside 9 is provided in particular for circumferential sealing on an inner surface 6 (not shown) of a cartridge 4 and for this purpose has a sealing groove 12 (not shown) with a seal 13.

In FIG. 4A, the closure element 2 of FIG. 2 is shown inserted into the piston of FIG. 3A, whereby the cartridge piston device 1 is completed or assembled. The cartridge piston device 1 is furthermore inserted into a cartridge 4 filled with cartridge contents 5, wherein the front side 7 of the piston 2 faces the cartridge content 5 and is spaced apart from the cartridge contents 5, so that an air-filled cavity 34 remains. The recess 11 has the present cylindrical recess 21 with a further sealing surface 47, the conical sealing surface 33 and the securing means 26 designed as a snap ring 26. There is a flowing transition from the recess 11 to a channel structure 10 which is fluidically connected to the recess 11, because the channel structure 10, at least substantially, has a same radius 29 or diameter or cross-section as a section of the recess 11 as a radius 28 or diameter.

In this case, the closure element 3 is in an open position relative to the piston 2 in FIG. 4A, wherein the cross section of the channel structure 10 is substantially fluidically blocked due to the guide section 20, but the venting option 41 formed as a groove 41 ensures a fluidic passage past the closure element 3. In the open position shown, the closure element 3 is arranged so as to be adjustable in a closed position fluidically closing the channel structure 10, because the closure element 3 is displaceable relative to the piston to the right (along the central axes 15, 22, 32 and in the insertion direction 18) in FIG. 4A.

For providing the open position in the open position in the recess 11, the closure element 3 of FIGS. 4A-B can strike against a securing means 26 designed as a snap ring 26 in the pull-out direction 19 with the securing section 25. The securing means 26 is inserted into a groove extending around the central axis in the region of the recess 11.

The closure element 3 of FIGS. 4A-B is held fixed in the recess 11 in the recess 11 by clamping in the region of the guide section 20 in order to provide the open position in the open position. Via the end face 16 of the closure element 3 oriented transversely to the central axes 22, 32 of the piston 2 and the closure element 3, the closure element 3 can be subjected to a force in the insertion direction 18. The insertion direction 18 points to the rear side 8 of the piston 2 and in the present case runs parallel to the central axes 15, 22, 32.

A pull-out direction 19 is arranged opposite to the insertion direction 18. When the closure element 3 is moved in the insertion direction 18 relative to the piston 2, the head side 17 dips into the countersink 21 and the sealing auxiliary element 23 comes into contact with the edge of the countersink 21, on which a circumferential, further sealing surface 47 is arranged, and seals there; furthermore, one or the gap 44 extends between the head side 17 and the bottom of the countersink 21, via which a fluidic passage to the recess 11 and to the channel structure 10 for venting is ensured.

It can be seen in FIG. 4A-B that the pre-channel structure 35 is less deep in the vicinity of the outside 9 or in the edge region 36 than in the vicinity of the countersink 21. Thus, the venting function and the manufacturability are improved because the pre-channel structure 35 can become clogged less quickly and because an average lower aspect ratio (depth/width) of grooves is generally easier to manufacture.

The outside 9 is provided with a sealing groove 12 running around the outside and a seal 13 contained in the sealing groove 12. In the present case, the seal 13 is an O-ring 13. On the outside 9 in the edge regions 36, scrapers 14 are provided, which are intended to avoid an escape of cartridge content 5 by stripping on the inner surface 6 of the cartridge 4, in particular in that the scrapers 14 bear continuously circumferentially and pressed against the inner surface 6.

The piston 2 has a diameter 45 of 60 mm +/−6 mm in the present case. Not shown, but also diameters 45 in the range of 10 mm to 200 mm or any integer individual value of diameter 45 therebetween are also possible. The diameter is regularly selected as a function of the diameter of a corresponding cartridge 4.

The piston has a thickness 46 of 15 mm +/−1, 5 mm in the present case. Not shown, but also thicknesses 46 in the range of 5 mm to 100 mm, or any integer individual value of the thickness 46 therebetween, are also possible. The selected thickness 46 depends decisively on which material is used, which diameter 45 is used and which resistance to deformation of the cartridge contents 5 is made.

The pre-channel structures 35 have a width 40 of 0.2 +/−0.15 mm in the present case. The depth 38, 39 of the pre-channel structures 35, measured along the central axis 32 of the piston 2 and measured from the plane of the front side 7 of the piston 2, measures at an end of 4 mm +/−1 mm as depth 39 in the edge region 36 or in the vicinity of the outside or edge depression 37, up to 2 mm +/−0.5 mm at the other end, i.e. in the vicinity of the countersink 21, as depth 38.

FIG. 4B shows the cartridge piston device 1 of FIG. 4A in a closed position, the cartridge contents 5 having pressed the closure element 3 into the closed position. In this case, the closure element 3 is pushed along the central axes 15, 22, 32 in the insertion direction 18 up to the stop of the rear side of the head 17 onto the bottom of the countersink 21 and up to the stop of the sealing element 24 on the sealing surface 33. The sealing element 24 seals on the sealing surface 33 against a fluidic passage along the closure element through the recess and through the channel structure. In addition, the sealing auxiliary element 23 or the sealing lip 23 in the countersink 21 seals all the way around the end face 16 in the countersink 21 on a circumferential further sealing surface 47. The annular gap 44 between the head side 17 and the bottom of the countersink 21 is closed or not present. The securing means 26 is located in the securing portion 25, but does not abut against the securing portion 25, but in this position is formed or able only to stop against the securing portion 25 in the pull-out direction 19.

FIG. 4B also shows the cartridge contents 5 which, when the cartridge piston device 1 is pushed in (with the adjusting element 3, originally in the open position, not shown), has been pressed or adjusted via the end face 16 into the closed position into the recess 11. In this case, for venting the cartridge 4 or air escape from the cavity 34 of the cartridge 4 by means of the pre-channel structure 35, past the gap 44, via the venting option 41 past the closure element 3 and on the rear side 8 out of the channel structure 10 of the piston 2, namely until finally—as shown—the closed position was present or is present.

It is noteworthy in FIG. 4B that the cartridge content 5 has penetrated into the pre-channel structures 35 despite its high viscosity and despite the narrow width or high aspect ratio of the pre-channel structures 35. It is advantageous here that the penetration through the depth 38, 39 of the pre-channel structures 35 that increases from the outside to the inside has likewise taken place from the outside to the inside, so that the air to be discharged from the cavity 34 has been discharged gradually and completely.

An embodiment of a cartridge piston device 1 in which no pre-channel structures 35, in particular none on the front side 7, are provided is not shown.

In FIGS. 1A-C and 4A-B, the cartridge 4 shown in each case has a piston opening 48 on the rear side, into which in the present case the cartridge piston device 1 can be inserted and inserted axially. In the present case, no further piston opening is shown on the side opposite the piston opening 48 (on the front side), but in particular at the remaining locations of the cartridge away from the piston opening 48, although this is typically provided.

As shown in FIG. 1 A-C, the cartridge 4 also has a front valve 49 as a further piston opening, in particular for removing the cartridge contents 5.

In particular, a further piston opening and/or a valve 49 is/are in principle arranged on the front side of the cartridge 4 and/or provided for using the filled, vented and closed cartridge 4, typically because the cartridge content 5 is to be pushed out of the cartridge during further insertion of the cartridge piston device 1 or the piston 2.

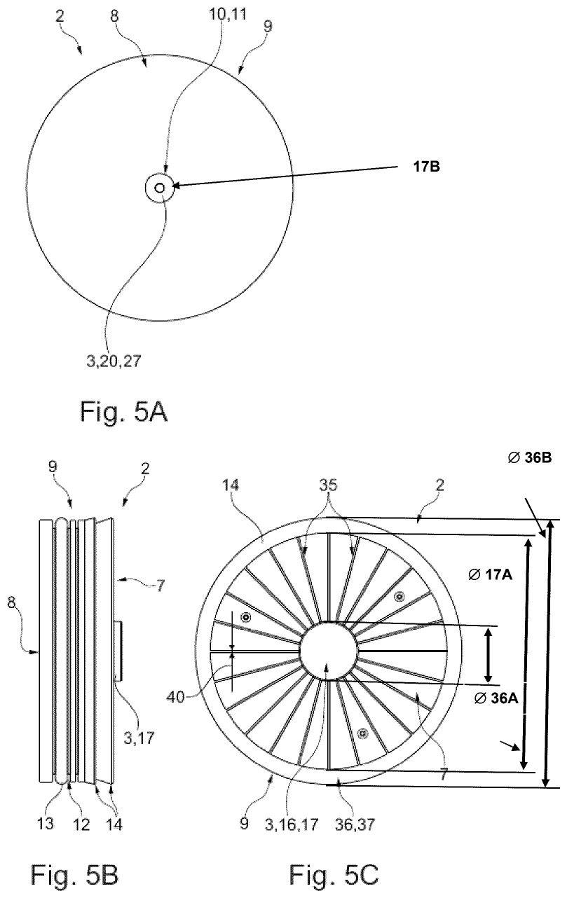

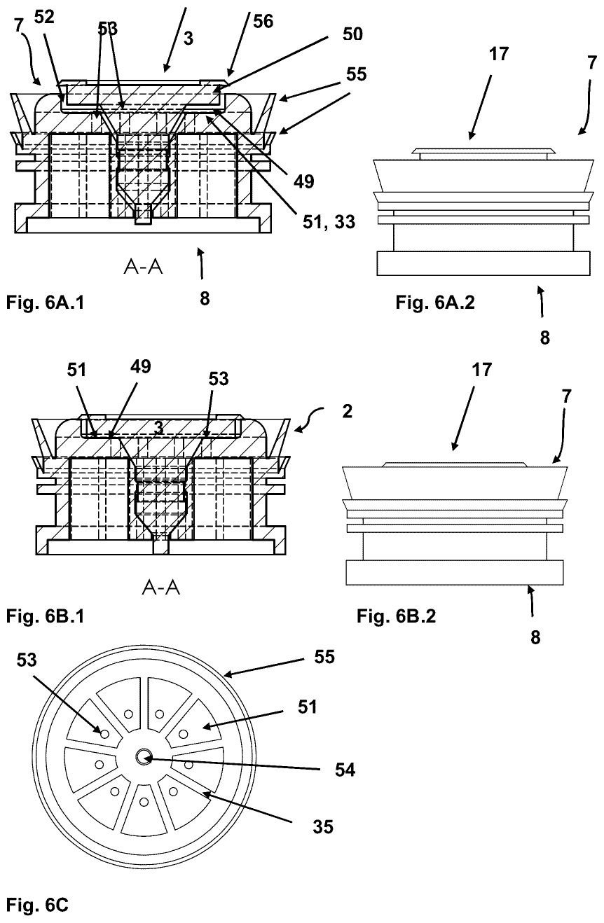

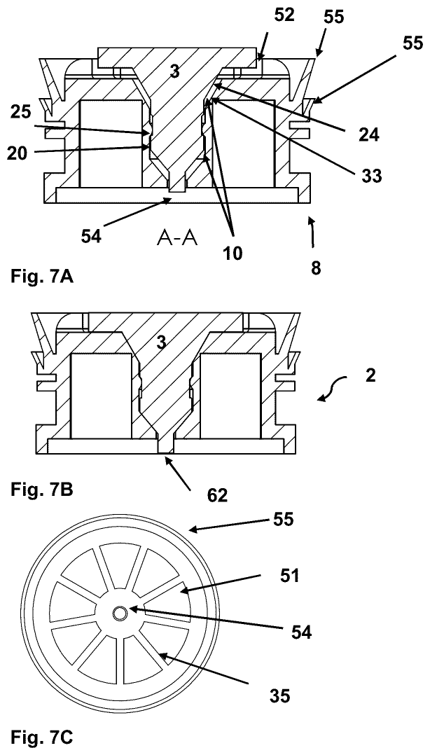

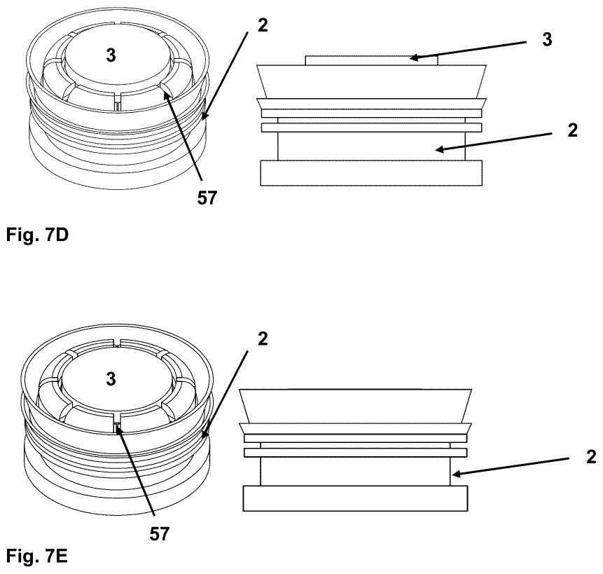

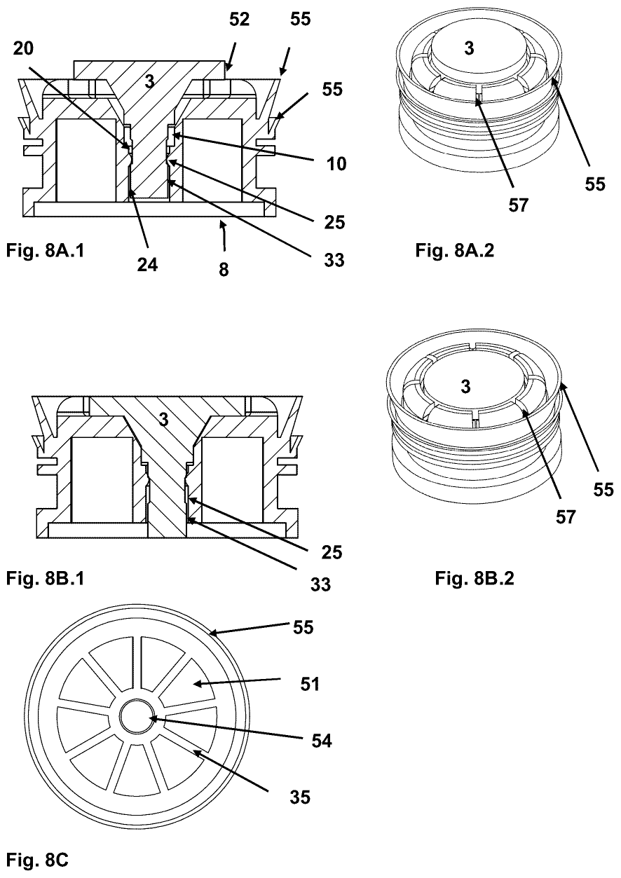

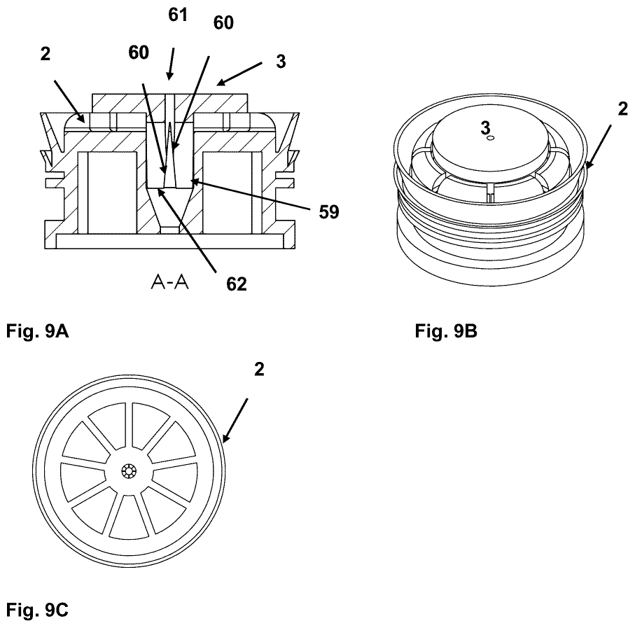

FIG. 5A-C shows a further embodiment of a cartridge piston device 1 according to the invention in various views. The head side 17 of the closure element 3 is designed as a cover 17B, in particular with the diameter 17A of the head side of the closure element. The cartridge piston device 1 shown in FIG. 5A-C is for insertion into a cartridge 4 and for venting and at the rear, the cartridge 4 is formed at the rear. FIG. 5A shows a piston 2 from its rear side 8, wherein a closure element 3 is inserted into a recess 11 in the region of the front side 7 (see FIG. 5C) on a front side 7 (see FIG. 5C) facing away from the rear side 8 and can be seen by a channel structure 10 centrally located on a central axis 22, 32. More precisely, a tapering 27 of the closure element 3 can be seen, which in the present case is designed as a truncated cone section 27. The closure element 3 is in an open position, so that a fluidic passage or fluidic connection, in particular for venting a cartridge 2, is possible from the rear side 8 through the channel structure 10 past the closure element 3 to the front side 7. The rear side 8 (or also the non-visible front side 7) is surrounded or surrounded by an outside 9; in other words, the outside 9 surrounds the rear side 8 and likewise the front side 7 (see FIG. 5C).

FIG. 5B shows the cartridge piston device 1 from the side or outside 9. On the outside 9 there is a sealing groove 12 and therein a seal 13 or O-ring 13 for circumferential sealing on a cartridge wall (not shown) or an inner surface 6 of a cartridge 4. the seal 13 projects radially from the outside 9. In addition, two strippers 14 are arranged circumferentially on the outside 9 and can rest against one or the cartridge wall or inner surface 6 of a cartridge 4 and can thereby be pressed elastically radially. The two scrapers 14 are located in the region of the outside 9 located on the front side 7 and face toward the front side 7 or face in the direction of the front side 7; opposite or in the region located on the rear side 8, the outside 9 is at least substantially cylindrical. The closure element 3 projects from the front side 7, since it is arranged in the open position. The closure element 3 is movably guided in an insertion direction 18, which points from the front side 7 to the rear side 8, into a closed position fluidically closing the channel structure 10. In this case, the closure element 3 for providing the open position in the open position is held non-positively fixed in the recess 11 by clamping by means of its guide section 20 (not shown). Furthermore, in the pull-out direction 19, the closure element 3 strikes against a securing means 26 in the recess 11 by means of its securing portion 25 (not shown in FIG. 5A-C).

FIG. 5C shows the cartridge piston device 1 with a view of the front side 7, wherein the closure element 3 is inserted in the recess 11 and is located in the open position. A flat, round end face 16 is located on the closure element 3 and at least substantially parallel to the front side 7; The end face 16 is part of a cylindrical head side 17 of the closure element 3. Between the head side 17 and a round countersink 21 arranged centrally on the front side 7 and corresponding to the head side 17, in particular end face 16 and/or rear side, (the countersink 21 is completely covered by the head side 17 in the illustration of FIG. 5C), in the open position shown, a gap 44 (which is likewise covered) parallel to the front side 7 is formed. Furthermore, a sealing auxiliary element 23, which is designed as a sealing lip 23, is arranged circumferentially around the head side 17, adjacent to the end face 26. The sealing auxiliary element 23 can seal circumferentially in the countersink 21, in particular in a closed position (not shown) of the closure element 3.

In the closed position (not shown), the gap 44 is closed or no longer exists. In the closed position, in an alternative, the closure element 3, in particular the head side 17, is not protruding from the front side 7 and is plan with the front side 7 or is sunk-in the front side, in particular because the closure element 3 has been pressed into the piston 2 along the insertion direction 18.

Radially, in particular spoke-shaped or star-shaped, from the center of the front side 7, in particular from the recess 11 and/or from the countersink 21, at least two, preferably at least four, particularly preferably two to fifty, outwardly open groove-shaped depressions 35 open towards the cartridge 4 (not shown) and form the pre-channel structures 35 up to the edge region 36, and open in particular in the present case in an edge depression 37 running around the front side 7. Radially, in particular spoke-shaped or star-shaped, from the center of the front side 7, in particular from the recess 11 and/or from the countersink 21, twenty-four outwardly open groove-shaped depressions 35 or pre-channel structures 35 open toward the outside toward the edge region 36 open toward the outside in FIG. 5C and thus open into an edge recess 37 running around the front side 7. In principle, the depressions 35 can also extend from the center of the front side 7, in particular the recess 11 and/or the countersink 21, into the edge region 36 and have any profile, such as for example length-cut, serrated, ladder-shaped and/or herringbone pattern, etc. The depressions 35 are arranged at least approximately flat-covering and distributed on the front side 7, so that it can be vented over a large area. In the vicinity of the edge region 36 of the front side 7, the pre-channel structures 35 are twice as deep (depth 39 is there 4 mm) as in the vicinity of the countersink 21 (depth 38 is 2 mm there). The pre-channel structures 35 have a width 40 of 0.2 mm, in particular of 0.2 mm to 1 mm, preferably less than or equal to 0.6 mm, circumferentially around the on the front side 7, one of the strippers 14 can be seen. In the present case, the pre-channel structures 35 are located on the front side 7, wherein an arrangement on the rear side 8 is alternatively or additionally also possible. The pre-channel structures 35 here connect the front side 7 to the recess 11, to the channel structure 10 and to the rear side 8 fluidically.

The piston 2 of FIG. 5A-C is at least substantially cylindrical (“at least substantially” because the scrapers 14 and the circumferential sealing groove 12 or seal 13 leave the outer contour from a cylindrical shape).

In the present case, the piston 2 and the closure element 3 of FIGS. 5A-C are parts produced by means of injection molding. The closure element 3 is made of a softer material (in particular a polymeric material) than the material of the piston 2 (in particular a polymeric material). In the present case, the closure element 3 is made of a thermoplastic elastomer and the piston 2 is made of a polyethylene, wherein alternatively or additionally a polypropylene (or other plastic) is also possible. These or other polymers or plastics are suitable as material for all parts mentioned in this application.

The cartridge piston device of FIG. 6A.1 to 6C is shown in the open position in FIG. 6A and in the closed position in FIG. 6B. The closure element 3 is inserted into the piston 2. In the open position, the head side 17 projects out of the front side of the piston, FIG. 6A.1 and 6A.2 The conveying-side rear side 8 of the piston 2 is shown in FIG. 6A.1 and 6A.2. The piston has openings 53 for venting in the support surface 51 for the rear side 49 of the head side of the closure element.

The head side of the closure element is designed as a cover 50. The cover has the end face, which is designed as a seal 56 and a rear side 49, which is likewise designed to seal the openings 53, see FIG. 6C, in that the rear side can close the support surface 51 for the rear side in a fluid-tight manner. The support surface 51 can be designed as a sealing surface 33. Due to the diameter of the head side of the closure element, this can be closed automatically by the action of force on the media side, in that a drive shaft of a mixer conveys a medium on the conveying side. In the open position, the groove 52 extending at least partially to completely around the head side is fluidically continuous and the air can escape through the openings 53 and optionally the channel structure. In the closed position, the groove 52 is closed fluid-by-fluid by the seal 56; FIG. 6B.1. The piston also has a sealing lip 55 encircling the outer circumference. In FIG. 6C, the piston is shown in plan view of the bearing surface of the rear side 51, which represents the openings 53 and the pre-channel structure 35, and a centering 54 in the direction of the rear side of the piston.

The cartridge piston device of FIGS. 7A to 7E is shown in the open position in FIG. 7A and in the closed position in FIG. 7B. The closure element 3 is inserted into the piston 2. In the open position, the head side projects out of the front side of the piston, FIG. 7A. The delivery-side rear side 8 of the piston 2 is shown in FIG. 7A. The piston has the bearing surface 51 as shown in FIG. 7C for the rear side of the head side of the closure element. The closure element has a tapering as securing section 25 and a guide section 20. The sealing surface in the recess of the piston 33 is shown in FIG. 7A. In the closed position, the sealing surfaces 33 and the conical seal 24 bear against one another and seal the cartridge piston device in a fluid-tight manner. The head side 17 of the closure element 3 is designed as a cover 17B. Due to the diameter 17A of the head side of the closure element, this can be closed automatically by the action of force on the media side, in that a drive shaft of a mixer conveys a medium on the conveying side. In the open position, the groove 52 extending at least partially to completely around the head side is fluidically continuous and the air can escape along the closure element through the channel structure 10. In the closed position, the channel structure 10 is closed fluidically by the sealing element in the configuration of a conical seal 24, FIG. 7B. The piston also has a sealing lip 55 encircling the outer circumference. The foot side is shown as 62. In FIG. 7 C the piston is shown in plan view of the bearing surface of the rear side 51, the pre-channel structure 35 represents and a centering 54 in the direction of the rear side of the piston.

FIGS. 7D and 7E show the open and closed position of the cartridge piston device comprising a piston 2 and a closure element 3 (7D open, 7E closed). Furthermore, the figures showed air inlet elements or radial grooves 57, which are arranged on the outside of the piston around the head side of the closure element.

The channel structure (not shown) with pre-channel structure 35 (FIG. 7C) preferably extends from the recess radially in the direction of the outer circumference of the piston. Particularly preferably, channel structure comprising a pre-channel structure extends radially outward from the recess in the direction of the outer circumference of the piston, wherein the pre-channel structure is arranged in the support surface 51 of the piston. In the closed position, the contact surface of the piston comes into contact with the rear side of the closure element, preferably the rear side of the closure element rests on the support surface, preferably in a fluidic manner.

The cartridge piston device of FIGS. 8A to 8C is shown in the open position in FIG. 8A and in the closed position in FIG. 8B. In the closed position, the head side of the closure element is pushed substantially into the piston. The closure element 3 is inserted into the piston. In the open position, the head side projects out of the front side of the piston, FIG. 8A. 1, 8A The delivery-side rear side 8 of the piston is shown in FIG. 8A. The piston has the bearing surface 51 as shown in FIG. 8C for the rear side of the head side of the closure element. The closure element has a tapering as securing section 25 and a guide section 20. The sealing surface in the recess of the piston 33 is shown in FIG. 7A. In the closed position, the sealing surfaces 33 and the cylindrical seal 24 bear against one another and seal the cartridge piston device in a fluid-tight manner. The head side 17 of the closure element is designed as a cover 17B. Due to the diameter 17A of the head side of the closure element, this can be closed automatically by the action of force on the media side, in that a drive shaft of a mixer conveys a medium on the conveying side. In the open position, the groove 52 extending at least partially to completely around the head side is fluidically continuous and the air can escape along the closure element through the channel structure 10. In the closed position, the channel structure 10 is closed fluidically by the sealing element in the configuration of the cylindrical seal 24, FIG. 8B. The piston also has a sealing lip 55 encircling the outer circumference. In FIGS. 7B and 7C, the piston is shown in plan view of the bearing surface of the rear side 51, which represents a pre-channel structure 35 and a centering 54 in the direction of the rear side of the piston. FIG. 8A.2 and 8B.2 show the open and closed position of the cartridge piston device comprising a piston and a closure element 3 (8A.2 open, 8B.2 closed). Furthermore, the figures show air inlet elements or radial grooves 57, which are arranged on the outside of the piston around the head side of the closure element.

FIGS. 9a to 9c show an alternative embodiment of a closure element 3 in a piston 2, in which the closure element 3 has an opening 61 on its head side. The opening 61 extends from the end face to the rear side of the head side and is guided through the closure element to the opposite end of the closure element, in particular as far as the foot side 62 of the closure element. The closure element has at least three elements 59 on the rear side opposite the end face, it is also possible to have 4 to 6 or more elements, each of which has at least one sealing surface 60, preferably two sealing surfaces 60, which are formed from the outer circumference of the elements 59 towards the opening 61. External application of force to the outer surfaces of the Elements 59 come to rest on the sealing surfaces 60 of two adjacent elements 59 and close the opening 61 of the closure element on the side facing away from the end face. The opening in the closure element preferably lies on and/or parallel to the longitudinal center axis of the closure element. The embodiment corresponds to a closure element with conical gaps, which is formed by the elements with sealing surfaces.

### LIST OF REFERENCE SIGNS

1 Cartridge piston device
2 Piston
3 Closure element
4 Cartridge
5 Cartridge content
6 Inner surface (of the cartridge)
7 Front side (of the piston), cartridge-side
8 Rear side (of the piston), on the conveying side
9 Outside (of the piston)
10 Channel structure
11 Recess
12 Sealing groove
13 Seal, O-ring
14 Stripper
15 Central axis (of the cartridge)
16 End face, cartridge-or media-side
17 Head side
17 A Diameter of the head side of the closure element 3
17 B Cover, in particular with diameter 17A of the head side 17 of the closure element
18 Insertion direction
19 pull-out direction
20 Guide section
21 Countersink (of the recess)
22 Central axis (of the closure element)
23 Sealing auxiliary element, sealing lip
24 Sealing element (of the closure element), cone
25 Securing section, tapering
26 Securing means, snap ring
27 Tapering, truncated cone, truncated cone section
28 Radius (of the recess)
29 Radius (of the channel structure)
30 Radius (of the guide section)
31 Diameter (of the guide section)
32 Central axis (of the piston)
33 Sealing surface (of the recess)
34 Cavity
35 Pre-channel structure
36 Edge region (of the piston)
36A A inner diameter edge region, in particular without edge depression
36B outer diameter edge region
37 Edge depression (of the piston), circumferential edge depression (of the piston)
38 Depth (of the pre-channel structure)
39 Depth (of the pre-channel structure)
40 Width (of the pre-channel structure)
41 Venting option, groove, slot
42 Depth (the venting option)
43 Width (the venting option)
44 Gap
45 Diameter (of the piston)
46 Thickness (of the piston)
47 further sealing surface (at the countersink)
48 Piston opening
49 Rear side, opposite to the end face
50 Lid
51 Support Surface Rear side
52 Groove
53 Openings
54 Centering
55 Sealing lip(s)
56 Sealing auxiliary element, sealing, protruding sealing lip
57 Air inlet element or radial groove
58 Second guide section
59 Elements with at least two sealing surfaces (60)
60 Sealing surfaces
61 Opening of the closure element
62 Foot side, Bottom side

1. Cartridge piston device (1) for insertion into a cartridge (4) and for venting and closing the cartridge (4) at its rear, having a piston (2), and having a closure element (3) for insertion into the piston (2), wherein the piston (2) has
a front side (7),
a rear side (8) facing away from the front side (7),
an outside (9) with a circumferential sealing groove (12) and/or seal (13) for circumferential sealing on an inner surface (6) of the cartridge (2),
the piston has a recess (11) in the region of the front side (7) for inserting the closure element (3) in an insertion direction (18), and
a channel structure (10) fluidically connecting the recess (11) and the rear side (8) for venting the cartridge (2), and
an insertion direction (18), which points at least substantially from the front side (7) to the rear side (8) and a pull-out direction (19) opposite to the insertion direction (18),
wherein the closure element (3) which is insertable into the recess (11) or at least part of the closure element (3) which is insertable into the recess (11)
is arrangeable so as to be adjustable in the insertion direction (18) from an open position fluidically releasing the channel structure (10) into a closed position fluidically closing the channel structure,
wherein the closure element has a head side (17) with an end face (16) and a sealing element, wherein
the closure element (3) for providing the open position is fixable in the recess (11) in the open position and/or strikes at least in the pull-out direction (19), and the piston (2) has, in the direction of the front side,
a support surface for the rear side (49) of the closure element, wherein the support surface is formed substantially perpendicular to the central axis of the piston and, which lies opposite to the end face (16) of the closure element (3), wherein
the piston (2) has a pre-channel structure (35) on the front side (7), wherein the pre-channel structure (35) connects the front side (7) fluidically with the recess (11), the channel structure (10) and/or the rear side (8),
the pre-channel structure (35) on the piston (2) has open and/or groove-shaped depressions towards the outside and/or towards the cartridge (4), wherein the depressions extend within the front side (7) from the center of the front side (7) and/or from the countersink (21) up to the edge region (36).

2. The cartridge piston device (1) according to claim 1, characterized in that the piston (2) has, in the direction of the front side (7), a support surface formed substantially perpendicular to the central axis of the piston in a depression formed on the front side for the rear side of the closure element which lies opposite to the end face (16) of the closure element (3).

3. Cartridge piston device (1) according to claim 1, characterized in that the closure element (3) has a head side (17) having an end face (16), and, wherein
at least in the open position, the end face (16) protrudes from the front side (7), and/or between the head side (17) and the piston (2) a gap (44) which opens fluidically in the recess (11) is formed, and/or
at least in the closed position, the end surface (16), at least substantially, terminates planar with the front side (7) or is sunk-in the front side (7).

4. Cartridge piston device (1) according to claim 3, characterized in that
the head side (17) and/or the end face (16) is formed on the recess (11) at least substantially round and/or corresponding to an countersink (21).

5. Cartridge piston device (1) according to one of claim 1, characterized in that the closure element (3) has a sealing element (24) for sealing on a sealing surface (33) of the recess (11).

6. Cartridge piston device (1) according to one of claim 1, characterized in that the closure element (3) has a sealing auxiliary element (23) for contact with a further sealing surface (47) of the countersink (21).

7. Cartridge piston device (1) according to claim 1, characterized in that the closure element (3) has a securing section (25) for securing the closure element (3) relative to the piston (2).

8. Cartridge piston device (1) according to one of claim 1, characterized in that the closure element (3) and/or the piston (2) in the region of the recess (11) and/or along the insertion direction (18) or pull-out direction (19), has a venting option (41).

9. Cartridge piston device (1) according to claim 1, characterized in that the piston (2) has a pre-channel structure (35) on the rear side (8), wherein the pre-channel structure (35):
connects the front side (7) fluidically with to the recess (11), the channel structure (10)—and/or the rear side (8), and/or
connects the rear side (8) fluidically with the channel structure (10) and/or the recess (11).

10. Cartridge piston device (1) according to claim 9, characterized in that the pre-channel structure (35), on the piston (2), has open and/or groove-shaped depressions open towards the outside and/or towards the cartridge (4).

11. Cartridge piston device (1) according to claim 9, characterized in that the pre-channel structure (35) on the piston (2) has open and/or groove-shaped depressions towards the outside and/or towards the cartridge (4), wherein the depressions extend within the front side (7) from the center of the front side (7) from the recess (11) and/or from the countersink (21) up to the edge region (36), and in particular open into the edge region.

12. Cartridge piston device (1) according to one of claim 1, characterized in that the ratio of the diameter of the head side of the closure element (3) to the diameter of the piston (2) is from 1:2 to 1:10 plus/minus 10%.

13. Cartridge piston device (1) according to claims 1, characterized in that the closure element (3) and/or the piston (2) is produced from one or more of: thermoplast, elastomer, duromer or duroplast, polypropylene (PP), polyethylene (PE) and/or a thermoplastic elastomer (TPE) and/or contains them.

14. A method for venting and closing a cartridge (4) with a cartridge piston device (1), the cartridge piston device (1)
having a piston (2) having a channel structure (10) and a closure element (3) for closing the channel structure (10) by inserting the closure element (3) into a recess (11) of the piston (2) in the region of the front side and by adjusting the closure element (3) into a closed position, or
according to preceding claim 1, wherein
the process is characterized by the following method steps
a. providing a cartridge with a piston opening (48),
b. providing the cartridge piston device (1),
c. inserting the cartridge piston device (1) into the piston opening (48), wherein a/the open position is present,
d. venting the cartridge (4) by inserting the cartridge piston device, wherein the closure element (3) is held fixed by the recess (11) and/or is stoppable in
the pull-out direction (19).

15-16. (canceled)

17. Piston (2) for insertion into a cartridge, characterized in that it has a front side (7), a rear side (8) facing away from the front side (7), an outside (9) with a circumferential sealing groove (12) and/or seal (13) for circumferential sealing on an inner surface (6) of the cartridge (4), having a recess (11) in the region of the front side (7) for inserting a closure element (3) in an insertion direction (18), and has a channel structure (10) fluidically connecting the recess (11) and the rear side (8) for venting the cartridge (4), and the piston (2) has, in the direction of the front side, a support surface for the rear side of the closure element, which is substantially perpendicular to the central axis of the piston and which lies opposite to the end face of the closure element (3), wherein the piston (2) has a pre-channel structure (35) on the front side (7), wherein the pre-channel structure (35) connects the front side (7) fluidically with the recess (11), the channel structure (10) and/or the rear side (8),
the pre-channel structure (35) on the piston (2) has open and/or groove-shaped depressions towards the outside and/or towards the cartridge (4), wherein the depressions extend within the front side (7) from the center of the front side (7) and/or from the countersink (21) up to the edge region (36).

18. Kit comprising at least one cartridge piston device according to claims 1 and a cartridge.

19. Use of a cartridge piston device (1) for insertion into a cartridge and back-side closure of the cartridge (4), wherein the cartridge piston device (1)
wherein the closure of the cartridge (4) includes an adjustment of the closure element (3) into the closed position, that the closure element (3) is brought about by contact of one or the cartridge contents (5) with the closure element (3) and/or by introduction of force.

20. Cartridge piston device (1) according to claim 1, wherein the piston (2) has an insertion direction (18), which points at least substantially from the front side (7) to the rear side (8) and a pull-out direction (19) opposite to the insertion direction (18) for the closure element.

21. Cartridge piston device (1) according to claim 3, characterized in that the closure element (3) has a head side (17) having an end face (16), and, preferably, wherein
at least in the open position, the end face (16) protrudes from the front side (7), and/or between the head side (17) and a countersink (21) of the piston, a gap (44) which opens fluidically in the recess (11) is formed, and/or
at least in the closed position, the end surface (16), at least substantially, terminates planar with the front side (7) or is sunk-in the front side (7), wherein the head side (17) is sunk-in further than in the open position.

22. Cartridge piston device (1) according to claim 10, characterized in that the groove-shaped depressions open towards the outside and/or towards the cartridge (4), wherein the groove-shaped depressions are arranged at or within the front side (7) and/or the rear side (8), at least approximately, in a surface-covering and/or distributed manner.

23. Method according to claim 14, wherein the cartridge is filled with cartridge contents.

24. Method according to claim 14, wherein the cartridge piston device (1) is provided with the closure element (3) inserted into the recess (11) and/or in an open position.

25. Method according to claim 14, comprising the step
e. closing the cartridge (4), by adjusting the closure element (3) into the closed position by contact of the cartridge content (5) with the closure element (3) and/or by applying force to the closure element (3) during or after step d.
